(19) United States
(12) Patent Application Publication
(10) Pub. No.: US 2014/0184480 A1
(43) Pub. Date: Jul. 3, 2014

(54) METHOD OF PERFORMING A MULTI-TIME PROGAMMABLE OPERATION AND DISPLAY DEVICE EMPLOYING THE SAME

(71) Applicant: SAMSUNG DISPLAY CO., LTD., Yongin-City (KR)

(72) Inventor: Hee-Chul LEE, Yongin-City (KR)

(73) Assignee: SAMSUNG DISPLAY CO., LTD., Yongin-City (KR)

(21) Appl. No.: 14/087,175

(22) Filed: Nov. 22, 2013

(30) Foreign Application Priority Data
Jan. 2, 2013 (KR) 10-2013-0000232

(51) Int. Cl. G09G 3/32

(52) U.S. Cl. CPC G09G 3/3208
USPC 345/82

(57) ABSTRACT

A method of performing a multi-time programmable (MTP) operation is provided. The method includes calculating respective MTP offsets at sub-reference gray-levels selected among predetermined reference gray-levels for respective pixel circuits, the MTP operation being performed at the predetermined reference gray-levels, determining respective offset reference values by assigning respective offset rooms based on the respective MTP offsets for the respective pixel circuits, the MTP operation being performed based on the respective offset reference values, and storing respective gamma offsets are stored by performing the MTP operation based on the respective offset reference values for the respective pixel circuits.

### CROSS-REFERENCE TO RELATED APPLICATION(S)

This application claims priority under 35 USC §119 to Korean Patent Applications No. 10-2013-0000232, filed on Jan. 2, 2013 in the Korean Intellectual Property Office (KIPO), the contents of which are incorporated herein in its entirety by reference.

### BACKGROUND

1. Technical Field

Example embodiments relate generally to a display device. More particularly, embodiments relate to a method of performing a multi-time programmable (MTP) operation, and a display device employing the same.

2. Description of the Related Art

Recently, an organic light emitting display device is widely used as a flat panel display device. As the organic light emitting display device is manufactured, an image quality of an end product (i.e., complete product) of the organic light emitting display device may not reach a target quality level because of deviations in a manufacturing process. In this case, the end product may be determined as a defective product, and the defective product may be discarded. However, discarding all end products determined as defective products is not efficient. Therefore, a post-correction for adjusting the image quality of the organic light emitting display device to reach the target quality level is required. Thus, an MTP operation for repeatedly performing the post-correction in luminance and color coordinate for respective pixel circuits is performed in order to adjust the image quality of the organic light emitting display device to reach the target quality level.

### SUMMARY

According to some example embodiments, a method of performing a multi-time programmable (MTP) operation may include calculating respective MTP offsets at sub-reference gray-levels that are selected among predetermined reference gray-levels for respective pixel circuits, the MTP operation being performed at the predetermined reference gray-levels, determining respective offset reference values by assigning respective offset rooms based on the respective MTP offsets for the respective pixel circuits, the MTP operation being performed based on the respective offset reference values, and storing respective gamma offsets by performing the MTP operation based on the respective offset reference values for the respective pixel circuits.

In example embodiments, the respective pixel circuits may include a red color pixel circuit, a green color pixel circuit, and a blue color pixel circuit.

In example embodiments, the respective pixel circuits may further include a white color pixel circuit.

In example embodiments, the sub-reference gray-levels may be at least two low-luminance reference gray-levels that are selected among the predetermined reference gray-levels.

In example embodiments, the respective offset reference values may be selected among an upper offset reference value, a lower offset reference value, and an initial offset reference value at the sub-reference gray-levels for the respective pixel circuits. Here, the upper offset reference value may be greater than the initial offset reference value, and the lower offset reference value may be smaller than the initial offset reference value.

In example embodiments, the upper offset reference value may correspond to a maximum value of an initial offset range, and the lower offset reference value may correspond to a minimum value of the initial offset range.

In example embodiments, the respective offset reference values may be set to be the maximum value of the initial offset range at the sub-reference gray-levels for the respective pixel circuits when the respective MTP offsets have a value greater than a predetermined maximum value for the respective pixel circuits.

In example embodiments, respective offset ranges may be moved upwardly with respect to the initial offset range at the sub-reference gray-levels for the respective pixel circuits when the respective offset reference values are set to be the maximum value of the initial offset range at the sub-reference gray-levels for the respective pixel circuits.

In example embodiments, the respective offset reference values may be set to be the minimum value of the initial offset range at the sub-reference gray-levels for the respective pixel circuits when the respective MTP offsets have a value smaller than a predetermined minimum value for the respective pixel circuits.

In example embodiments, respective offset ranges may be moved downwardly with respect to the initial offset range at the sub-reference gray-levels for the respective pixel circuits when the respective offset reference values are set to be the minimum value of the initial offset range at the sub-reference gray-levels for the respective pixel circuits.

In example embodiments, the respective offset reference values may be set to be the initial offset reference value at the sub-reference gray-levels for the respective pixel circuits when the respective MTP offsets have a value between a predetermined minimum value and a predetermined maximum value for the respective pixel circuits.

In example embodiments, respective offset ranges may correspond to the initial offset range at the sub-reference gray-levels for the respective pixel circuits when the respective offset reference values are set to be the initial offset reference value at the sub-reference gray-levels for the respective pixel circuits.

In example embodiments, respective offset ranges may correspond to the initial offset range at the predetermined reference gray-levels except for the sub-reference gray-levels for the respective pixel circuits.

According to some example embodiments, a display device may include a display panel having a plurality of pixel circuits, a scan driving unit that provides a scan signal to the pixel circuits, a data driving unit that provides a data signal to the pixel circuits, a power unit that provides a high power voltage and a low power voltage to the pixel circuits, a multi-time programmable (MTP) processing unit that performs an MTP operation by calculating respective MTP offsets at sub-reference gray-levels that are selected among predetermined reference gray-levels for the respective pixel circuits, and by determining respective offset reference values based on the respective MTP offsets for the respective pixel circuits, and a timing control unit that controls the scan driving unit, the data driving unit, the power unit, and the MTP processing unit.

In example embodiments, the respective pixel circuits may include a red color pixel circuit, a green color pixel circuit, and a blue color pixel circuit.

In example embodiments, the respective pixel circuits may further include a white color pixel circuit.

In example embodiments, the sub-reference gray-levels may be at least two low-luminance reference gray-levels that are selected among the predetermined reference gray-levels.

In example embodiments, the respective offset reference values may be selected among an upper offset reference value, a lower offset reference value, and an initial offset reference value at the sub-reference gray-levels for the respective pixel circuits. Here, the upper offset reference value may be greater than the initial offset reference value, and the lower offset reference value may be smaller than the initial offset reference value.

In example embodiments, the MTP processing unit may determine the respective offset reference values by assigning respective offset rooms based on the respective MTP offsets for the respective pixel circuits, and may store respective gamma offsets by performing the MTP operation based on the respective offset reference values for the respective pixel circuits.

In example embodiments, the MTP processing unit may adjust the data signal based on the respective gamma offsets for the respective pixel circuits.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of performing a multi-time programmable (MTP) operation according to example embodiments.

FIG. 2 is a diagram illustrating an example in which an MTP operation is performed on respective pixel circuits included in a display panel by a method of FIG. 1.

FIG. 3 is a diagram illustrating an example in which an MTP operation is performed on respective pixel circuits based on different offset reference values by a method of FIG. 1.

FIG. 4 is a flow chart illustrating an example in which an offset room assignment is decided for respective pixel circuits by a method of FIG. 1.

FIG. 5 is a flow chart illustrating an example in which an offset room is assigned for respective pixel circuits by a method of FIG. 1.

FIG. 6 is a block diagram illustrating an organic light emitting display device according to example embodiments.

FIG. 7 is a block diagram illustrating an MTP processing unit included in an organic light emitting display device of FIG. 6.

FIG. 8 is a block diagram illustrating an organic light emitting display device according to example embodiments.

FIG. 9 is a block diagram illustrating an electronic device having an organic light emitting display device according to example embodiments.

FIG. 10 is a diagram illustrating an example in which an electronic device of FIG. 9 is implemented as a smart-phone.

### DETAILED DESCRIPTION

Various example embodiments will be described more fully hereinafter with reference to the accompanying drawings, in which some example embodiments are shown. These may, however, be embodied in many different forms and should not be construed as limited to the example embodiments set forth herein. Rather, these example embodiments are provided so that this disclosure will be thorough and complete, and will fully convey the scope of the present disclosure to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of herein. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

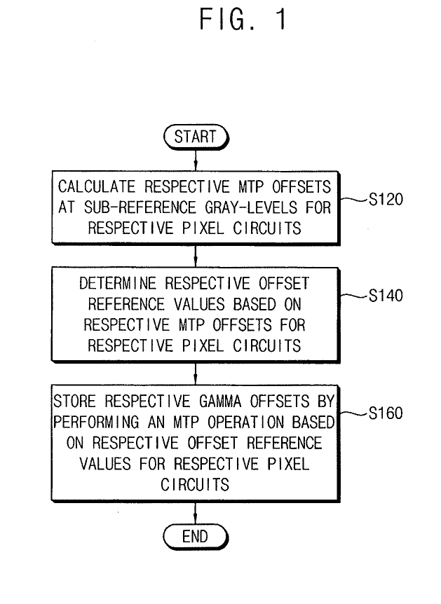

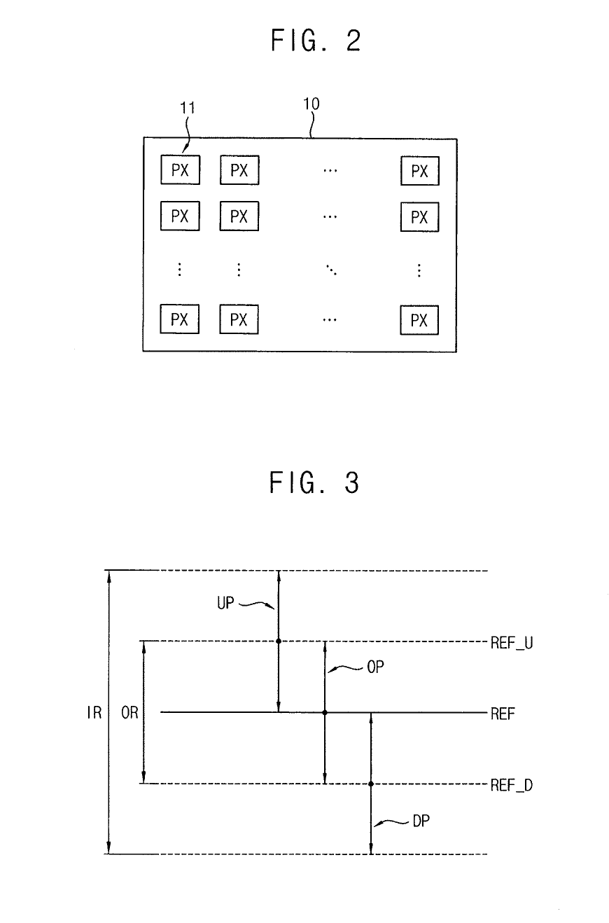

FIG. 1 is a flow chart illustrating a method of performing a multi-time programmable (MTP) operation according to example embodiments. FIG. 2 is a diagram illustrating an example in which an MTP operation is performed on respective pixel circuits included in a display panel by a method of FIG. 1. FIG. 3 is a diagram illustrating an example in which an MTP operation is performed on respective pixel circuits based on different offset reference values by a method of FIG. 1.

Referring to FIGS. 1 through 3, the method of FIG. 1 may calculate respective MTP offsets at sub-reference gray-levels that are selected among predetermined reference gray-levels, where an MTP operation is performed at the reference gray-levels, for respective pixel circuits 11 (operation S120), may determine (i.e., change) respective offset reference values, where the MTP operation is performed based on (i.e., with respect to) the respective offset reference values, by assigning respective offset rooms (i.e., referred to as offset registers) based on the respective MTP offsets for the respective pixel circuits 11 (operation S140), and may store respective gamma offsets by performing the MTP operation based on the respective offset reference values for the respective pixel circuits 11 (operation S160).

Generally, an MTP operation for repeatedly performing a post-correction in luminance and color coordinate for the respective pixel circuits 11 of a display panel 10 is performed in order to adjust an image quality of the organic light emitting display device to reach a target quality level. The MTP operation may be performed by storing the respective gamma offsets based on comparison between a reference gamma curve and respective actual gamma curves that are generated based on a pixel gamma curve. For example, the reference gamma curve may be substantially identical to the pixel gamma curve. Here, the pixel gamma curve indicates a gamma curve that is selected for the respective pixel circuits 11 to perform the MTP operation. In addition, the respective actual gamma curves indicate respective gamma curves that are obtained by performing tests based on the pixel gamma curve for the respective pixel circuits 11. Further, the reference gamma curve indicates a gamma curve (e.g., GAMMA CURVE 2.2) that is set for displaying (i.e., outputting) an image in the organic light emitting display device. To improve an ability of the MTP operation, an original offset range (e.g., an initial offset range OR) of the respective gamma offsets must be increased. However, it is difficult to increase the original offset range of the respective gamma offsets because a size of a driving integrated circuit (D-IC) has limits and/or a time required for the MTP operation has limits.

In contrast, the method of FIG. 1 may perform the MTP operation in a wider range IR without increasing the original offset range of the respective gamma offsets when the MTP operation is performed on the respective pixel circuits 11. For this operation, the method of FIG. 1 may set respective offset design values (i.e., the respective offset reference values) at the sub-reference gray-levels that are selected among the reference gray-levels in a plurality of offset rooms included in the driving integrated circuit, and may assign the most adequate offset room by checking a value of the respective MTP offsets for the respective pixel circuits 11. Hereinafter, the method of FIG. 1 will be specifically described.

The method of FIG. 1 may calculate the respective MTP offsets at the sub-reference gray-levels that are selected among the reference gray-levels for the respective pixel circuits 11 (operation S120). For example, the method of FIG. 1 may calculate the respective MTP offsets by comparing the actual gamma curve with the reference gamma curve at the sub-reference gray-levels for the respective pixel circuits 11.

In one example embodiment, the sub-reference gray-levels may be at least two adjacent low-luminance reference gray-levels that are selected in a row among the reference gray-levels. Since a value of the respective MTP offsets is usually small at high-luminance reference gray-levels, the at least two adjacent low-luminance reference gray-levels may be selected in a row among the reference gray-levels as the sub-reference gray-levels. For example, when the reference gray-levels includes 1 gray-level, 15 gray-level, 35 gray-level, 59 gray-level, 87 gray-level, 171 gray-level, and 255 gray-level, the at least two low-luminance reference gray-levels (e.g., the 1 gray-level and the 15 gray-level) may be selected as the sub-reference gray-levels.

In another example embodiment, the sub-reference gray-levels may be at least two non-adjacent low-luminance reference gray-levels that are selected (i.e., not in a row) among the reference gray-levels. Since a value of the respective MTP offsets can be large at the high-luminance reference gray-levels as a resolution of the organic light emitting display device increases, the at least two non-adjacent low-luminance reference gray-levels may be selected among the reference gray-levels as the sub-reference gray-levels. For example, when the reference gray-levels includes the 1 gray-level, the 15 gray-level, the 35 gray-level, the 59 gray-level, the 87 gray-level, the 171 gray-level, and the 255 gray-level, the at least two low-luminance reference gray-levels (e.g., the 1 gray-level and the 35 gray-level) may be selected as the sub-reference gray-levels.

The method of FIG. 1 may determine the respective offset reference values by assigning the respective offset rooms based on the respective MTP offsets for the respective pixel circuits 11 (operation S140). That is, at the sub-reference gray-levels, the respective offset reference values may be selected among an upper offset reference value REF_U, a lower offset reference value REF_D, and an initial offset reference value REF for the respective pixel circuits 11. As illustrated in FIG. 3, the upper offset reference value REF_U is greater than the initial offset reference value REF, and the lower offset reference value REF_D is smaller than the initial offset reference value REF. As a result, at the sub-reference gray-levels, respective offset ranges may be selected among an upper offset range UP, a lower offset range DP, and an initial offset range OP for the respective pixel circuits 11.

For example, the upper offset reference value REF_U may correspond to a maximum value of the initial offset range OP, and the lower offset reference value REF_D may correspond to a minimum value of the initial offset range OP. Specifically, when the respective MTP offsets have a value greater than a predetermined maximum value for the respective pixel circuits 11, the respective offset reference values may be set to be the maximum value of the initial offset range OP (e.g., the upper offset reference value REF_U) at the sub-reference gray-levels for the respective pixel circuits 11. When the respective MTP offsets have a value smaller than a predetermined minimum value for the respective pixel circuits 11, the respective offset reference values may be set to be the minimum value of the initial offset range OP (e.g., the lower offset reference value REF_D) at the sub-reference gray-levels for the respective pixel circuits 11. The predetermined maximum and minimum values may be variously set according to required conditions for the organic light emitting display device.

As illustrated in FIG. 3, when the respective offset reference values are set to be the maximum value of the initial offset range OP (e.g., the upper offset reference value REF_U) at the sub-reference gray-levels for the respective pixel circuits 11, the respective offset range may be determined to be upper offset range UP for the respective pixel circuits 11. When the respective offset reference values are set to be the minimum value of the initial offset range OP (e.g., the lower offset reference value REF_D) at the sub-reference gray-levels for the respective pixel circuits 11, the respective offset range may be determined to be lower offset range DP for the respective pixel circuits 11. When the respective MTP offsets have a value between the predetermined maximum value and the predetermined minimum value for the respective pixel circuits 11, the respective offset reference values are set to be the initial offset reference value REF at the sub-reference gray-levels for the respective pixel circuits 1 I. In this case, the respective offset range may be determined to be the initial offset range OP at the sub-reference gray-levels for the respective pixel circuits 11.

As described above, when the MTP operation is performed on the respective pixel circuits 11, the method of FIG. 1 may determine the respective offset ranges (i.e., may select the respective offset ranges among the upper offset range UP, the lower offset range DP, and the initial offset range OP) at the sub-reference gray-levels for the respective pixel circuits 11 by checking a value of the respective MTP offsets for the respective pixel circuits 11. As a result, the method of FIG. 1 may perform the MTP operation in a wider range IR without increasing the original offset range of the respective gamma offsets for the respective pixel circuits 11. In example embodiments, the respective offset ranges may be set to be the initial offset range OP at the reference gray-levels except for the sub-reference gray-levels for the respective pixel circuits 11. According to required conditions for the organic light emitting display device, however, the respective offset ranges may also be set to be one of the upper offset range UP, the lower offset range DP, and the initial offset range OP at the reference gray-levels for the respective pixel circuits 11.

Next, the method of FIG. 1 may store the respective gamma offsets by performing the MTP operation based on the respective offset reference values (e.g., the respective offset reference values are selected among the upper offset reference value REF_U, the lower offset reference value REF_D, and the initial offset reference value REF for the respective pixel circuits 11) for the respective pixel circuits 11 (operation S160). Thus, the MTP operation may be performed in the wider range IR while maintaining the initial offset range OR of the respective gamma offsets for the respective pixel circuits 11, because the MTP operation is performed based on the respective offset reference values that are determined (i.e., changed) based on the respective MTP offsets for the respective pixel circuits 11.

In one example embodiment, the respective pixel circuits 11 may include a red color pixel circuit (i.e., a pixel circuit emitting a red color light), a green color pixel circuit (i.e., a pixel circuit emitting a green color light), and a blue color pixel circuit (i.e., a pixel circuit emitting a blue color light). In this case, the method of FIG. 1 may be applied to the red color pixel circuit, the green color pixel circuit, and the blue color pixel circuit, respectively. In another example embodiment, the respective pixel circuits 11 may include a red color pixel circuit (i.e., a pixel circuit emitting a red color light), a green color pixel circuit (i.e., a pixel circuit emitting a green color light), a blue color pixel circuit (i.e., a pixel circuit emitting a blue color light), and a white color pixel circuit (i.e., a pixel circuit emitting a white color light). In this case, the method of FIG. 1 may be applied to the red color pixel circuit, the green color pixel circuit, the blue color pixel circuit, and the white color pixel circuit, respectively.

By way of summation and review, the method of FIG. 1 may perform the MTP operation in a wide range by calculating the respective MTP offsets at the sub-reference gray-levels that are selected among the reference gray-levels for the respective pixel circuits 11 and by determining (i.e., changing) the respective offset reference values based on the respective MTP offsets for the respective pixel circuits 11.

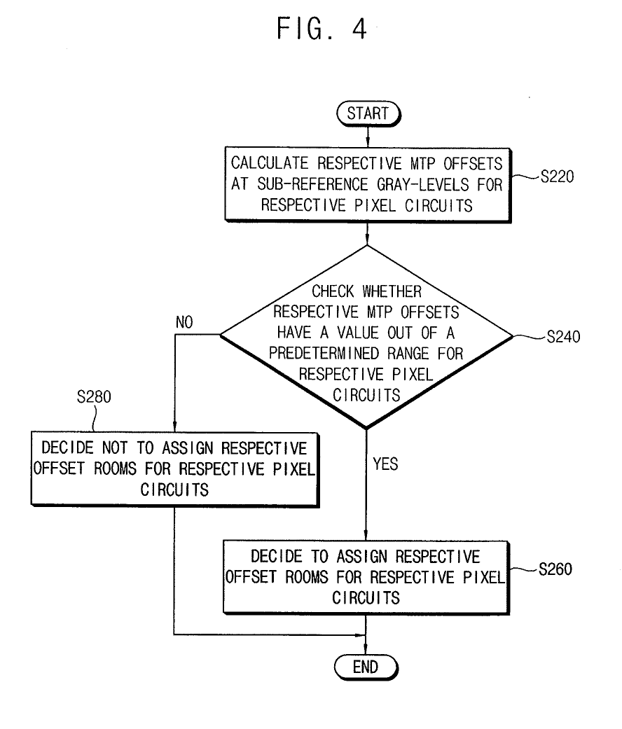

FIG. 4 is a flow chart illustrating an example in which an offset room assignment is decided for respective pixel circuits by a method of FIG. 1. Referring to FIG. 4, it is illustrated that an offset room assignment is decided for respective pixel circuits by the method of FIG. 1.

The method of FIG. 1 may calculate respective MTP offsets at sub-reference gray-levels that are selected among predetermined reference gray-levels for the respective pixel circuits (operation S220), and may check whether the respective MTP offsets have a value out of a predetermined range for the respective pixel circuits (operation S240). Here, the predetermined range may be variously set according to required conditions for an organic light emitting display device. Specifically, the method of FIG. 1 may check whether the respective MTP offsets have a value greater than a maximum value of the predetermined range (i.e., referred to as a predetermined maximum value) for the respective pixel circuits, may check whether the respective MTP offsets have a value smaller than a minimum value of the predetermined range (i.e., referred to as a predetermined minimum value) for the respective pixel circuits, and may check whether the respective MTP offsets have a value between the predetermined maximum value and the predetermined minimum value for the respective pixel circuits.

Subsequently, when the respective MTP offsets have a value out of the predetermined range for the respective pixel circuits, the method of FIG. 1 may decide to assign respective offset rooms for the respective pixel circuits (operation S260) because it is required to change respective offset ranges at the sub-reference gray-levels for the respective pixel circuits. That is, the method of FIG. 1 may perform an MTP operation in a wide range by changing the respective offset ranges at the sub-reference gray-levels (e.g., moving the respective offset ranges at the sub-reference gray-levels upwardly or downwardly with respect to an initial offset range) for the respective pixel circuits. On the other hand, when the respective MTP offsets have a value within the predetermined range for the respective pixel circuits, the method of FIG. 1 may decide not to assign the respective offset rooms for the respective pixel circuits (operation S280), because it is not required to change the respective offset ranges at the sub-reference gray-levels for the respective pixel circuits.

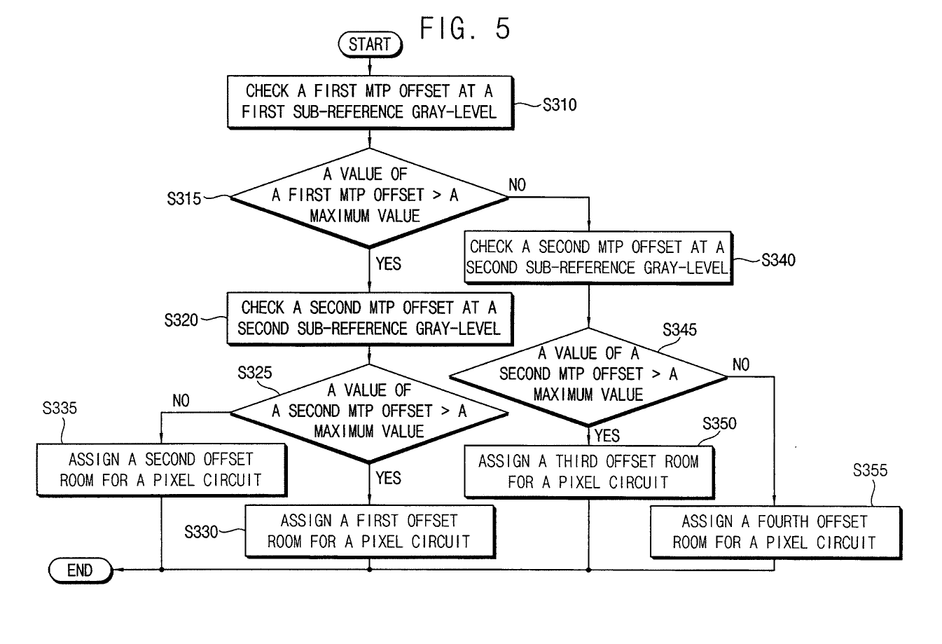

FIG. 5 is a flow chart illustrating an example in which an offset room is assigned for respective pixel circuits by a method of FIG. 1. Referring to FIG. 5, it is illustrated that an offset room is assigned for respective pixel circuits by the method of FIG. 1.

For convenience, it is assumed that two sub-reference gray-levels (i.e., a first sub-reference gray-level and a second sub-reference gray-level, e.g., 1 gray-level and 15 gray-level, or 1 gray-level and 35 gray-level) are selected among predetermined reference gray-levels (e.g., 1 gray-level, 15 gray-level, 35 gray-level, 59 gray-level, 87 gray-level, 171 gray-level, and 255 gray-level). In addition, it is also assumed that respective MTP offsets calculated at the sub-reference gray-levels have a value out of a predetermined range (i.e., a value greater than a predetermined maximum value or a value smaller than a predetermined minimum value) for the respective pixel circuits.

Specifically, the method of FIG. 1 may check a first MTP offset at the first sub-reference gray-level (operation S310), and may determine whether the first MTP offset has a value greater than the predetermined maximum value (operation S315). When the first MTP offset has a value greater than the predetermined maximum value, the method of FIG. 1 may check a second MTP offset at the second sub-reference gray-level (operation S320) and may further determine whether the second MTP offset has a value greater than the predetermined maximum value (operation S325). When the second MTP offset has a value greater than the predetermined maximum value, the method of FIG. 1 may assign a first offset room for a pixel circuit (operation S330). On the other hand, when the second MTP offset has a value smaller than the predetermined minimum value, the method of FIG. 1 may assign a second offset room for the pixel circuit (operation S335). In addition, when the first MTP offset has a value smaller than the predetermined minimum value, the method of FIG. 1 may check the second MTP offset at the second sub-reference gray-level (operation S340) and may further determine whether the second MTP offset has a value greater than the predetermined maximum value (operation S345). When the second MTP offset has a value greater than the predetermined maximum value, the method of FIG. 1 may assign a third offset room for the pixel circuit (operation S350). On the other hand, when the second MTP offset has a value smaller than the predetermined minimum value, the method of FIG. 1 may assign a fourth offset room for the pixel circuit (operation S355).

As described above, the method of FIG. 1 may determine (i.e., change) respective offset reference values (e.g., may move respective offset ranges at the sub-reference gray-levels upwardly or downwardly with respect to an initial offset range) for the respective pixel circuits by assigning respective offset rooms based on the respective MTP offsets for the respective pixel circuits. Meanwhile, when the sub-reference gray-levels (e.g., the 1 gray-level and the 15 gray-level, or the 1 gray-level and the 35 gray-level) are selected among the reference gray-levels (e.g., the 1 gray-level, the 15 gray-level, the 35 gray-level, the 59 gray-level, the 87 gray-level, the 171 gray-level, and the 255 gray-level), the sub-reference gray-levels may be at least two adjacent low-luminance reference gray-levels (e.g., the 1 gray-level and the 15 gray-level) that are selected in a row among the reference gray-levels (i.e., shown in Table 1 below), when a value of the respective MTP offsets is usually small at high-luminance reference gray-levels. Alternatively, the sub-reference gray-levels may be at least two non-adjacent low-luminance reference gray-levels (e.g., the 1 gray-level and the 35 gray-level) that are selected (i.e., not in a row) among the reference gray-levels (i.e., shown in Table 2 below), when a value of the respective MTP offsets can be large at the high-luminance reference gray-levels as a resolution of an organic light emitting display device increases.

TABLE 1

| | V1 | V15 | V35 | V59 | V87 | V171 | V255 |
|---|---|---|---|---|---|---|---|
| OFFSET ROOM1 | −127 | −127 | 0 | 0 | 0 | 0 | 0 |
| OFFSET ROOM2 | −127 | +128 | 0 | 0 | 0 | 0 | 0 |
| OFFSET ROOM3 | +128 | −127 | 0 | 0 | 0 | 0 | 0 |
| OFFSET ROOM4 | +128 | +128 | 0 | 0 | 0 | 0 | 0 |

TABLE 2

| | V1 | V15 | V35 | V59 | V87 | V171 | V255 |
|---|---|---|---|---|---|---|---|
| OFFSET ROOM1 | −127 | 0 | −127 | 0 | 0 | 0 | 0 |
| OFFSET ROOM2 | −127 | 0 | +128 | 0 | 0 | 0 | 0 |
| OFFSET ROOM3 | +128 | 0 | −127 | 0 | 0 | 0 | 0 |
| OFFSET ROOM4 | +128 | 0 | +128 | 0 | 0 | 0 | 0 |

In conclusion, the method of FIG. 1 may perform the MTP operation in a wide range without increasing an original offset range of the respective gamma offsets when the MTP operation is performed on the respective pixel circuits. For this operation, the method of FIG. 1 may set respective offset reference values at the sub-reference gray-levels (e.g., the 1 gray-level and the 15 gray-level, or the 1 gray-level and the 35 gray-level) that are selected among the reference gray-levels (e.g., the 1 gray-level, the 15 gray-level, the 35 gray-level, the 59 gray-level, the 87 gray-level, the 171 gray-level, and the 255 gray-level) in a plurality of offset rooms included in a driving integrated circuit, and may assign the most adequate offset room by checking a value of the respective MTP offsets for the respective pixel circuits 11. As shown in Table 1 and [Table 2], since the two sub-reference gray-levels (e.g., the 1 gray-level and the 15 gray-level or the 1 gray-level and the 35 gray-level) are selected among the reference gray-levels (e.g., the 1 gray-level, the 15 gray-level, the 35 gray-level, the 59 gray-level, the 87 gray-level, the 171 gray-level, and the 255 gray-level), four offset rooms are required (i.e., 2*2=4).

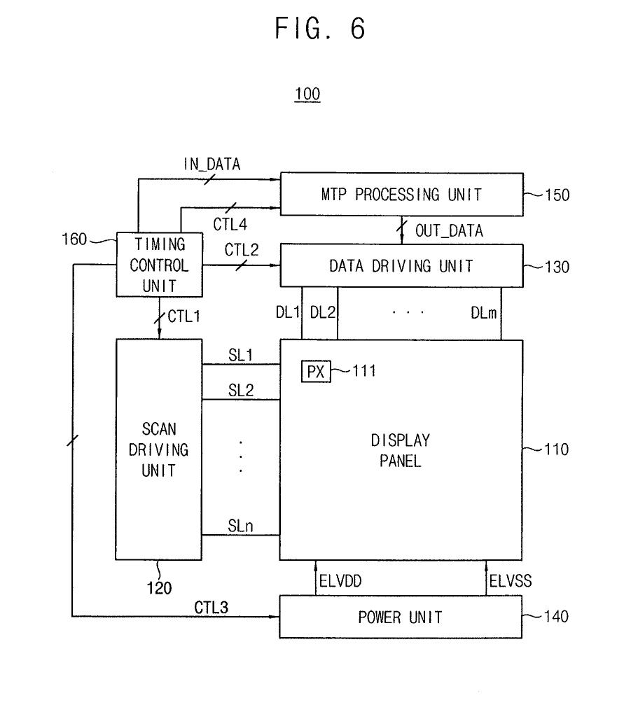

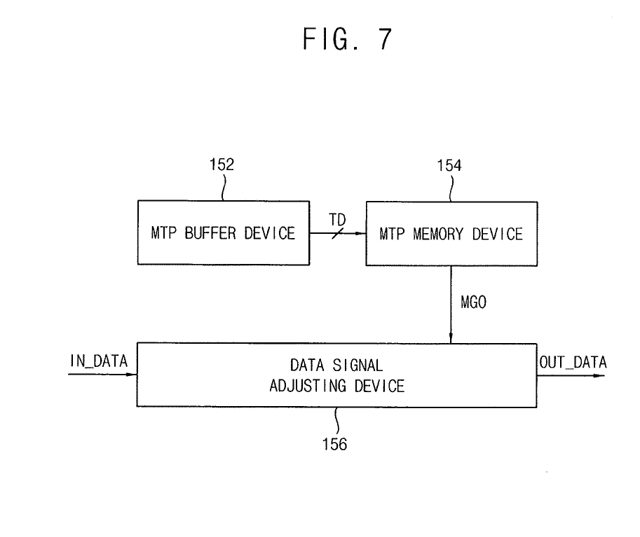

FIG. 6 is a block diagram illustrating an organic light emitting display device according to example embodiments. FIG. 7 is a block diagram illustrating an MTP processing unit included in an organic light emitting display device of FIG. 6.

Referring to FIGS. 6 and 7, the organic light emitting display device 100 may include a display panel 110, a scan driving unit 120, a data driving unit 130, a power unit 140, an MTP processing unit 150, and a timing control unit 160. For example, the organic light emitting display device 100 may employ a sequential emission driving technique.

The display panel 110 may include pixel circuits 111. The display panel 110 may be coupled to the scan driving unit 120 via scan-lines SL1 through SLn, and may be coupled to the data driving unit 130 via data-lines DL1 through DLm. Here, the display panel 110 may include n*m pixel circuits 111 because the pixel circuits 111 are arranged at locations corresponding to crossing points of the scan-lines SL1 through SLn and the data-lines DL1 through DLm. In one example embodiment, the pixel circuits 111 may include red color pixel circuits, green color pixel circuits, and blue color pixel circuits. In another example embodiment, the pixel circuits 111 may include red color pixel circuits, green color pixel circuits, blue color pixel circuits, and white color pixel circuits. The scan driving unit 120 may provide a scan signal to the pixel circuits 111 via the scan-lines SL1 through SLn. The data driving unit 130 may provide a data signal to the pixel circuits 111 via the data-lines DL1 through DLm. The power unit 140 may provide a high power voltage ELVDD and a low power voltage ELVSS to the pixel circuits 111 via power-lines.

The MTP processing unit 150 may perform an MTP operation by calculating respective MTP offsets at sub-reference gray-levels that are selected among predetermined reference gray-levels, where the MTP operation is performed at the reference gray-levels, for the respective pixel circuits 111, and by changing respective offset reference values, where the MTP operation is performed based on the respective offset reference values, based on the respective MTP offsets for the respective pixel circuits 111. Specifically, the MTP processing unit 150 may calculate the respective MTP offsets at the sub-reference gray-levels that are selected among the reference gray-levels for the respective pixel circuits 111, may determine (i.e., change) the respective offset reference values by assigning respective offset rooms based on the respective MTP offsets for the respective pixel circuits 111, and may store respective gamma offsets MGO by performing the MTP operation based on the respective offset reference values for the respective pixel circuits 111. Thus, when the organic light emitting display device 100 outputs an image, the MTP processing unit 150 may adjust the data signal (i.e., may convert an input data signal IN_DATA into an output data signal OUT_DATA) based on the respective gamma offsets MGO for the respective pixel circuits 111.

As illustrated in FIG. 7, the MTP processing unit 150 may include an MTP buffer device 152, an MTP memory device 154, and a data signal adjusting device 156. Here, the MTP memory device 154 may include the offset rooms (i.e., referred to as offset registers) having information related to a plurality of offset reference values that are stored at the sub-reference gray-levels, where the sub-reference gray-levels are selected among the reference gray-levels. Specifically, the MTP memory device 154 may receive data TD that are finally updated in the MTP buffer device 152 from the MTP buffer device 152, and may store the data TD as the respective gamma offsets MGO for the respective pixel circuits 111. In addition, the data signal adjusting device 156 may adjust the data signal based on the respective gamma offsets MGO for the respective pixel circuits 111. Since a structure of the MTP processing unit 150 is exemplary, the structure of the MTP processing unit 150 may be designed in various ways.

The timing control unit 160 may control the scan driving unit 120, the data driving unit 130, the power unit 140, and the MTP processing unit 150 based on first through fourth control signals CTL1, CTL2, CTL3, and CTL4. In conclusion, the organic light emitting display device 100 may perform the MTP operation in a wide range by calculating the respective MTP offsets at the sub-reference gray-levels that are selected among the reference gray-levels for the respective pixel circuits 111, and by determining the respective offset reference values based on the respective MTP offsets (i.e., by assigning the respective offset rooms depending on a size of the respective MTP offsets). As a result, the organic light emitting display device 100 may display (i.e., output) a high-quality image by performing the MTP operation in a wide range.

In one example embodiment, as illustrated in FIG. 6, the MTP processing unit 150 may be located outside the timing control unit 160 and the data driving unit 130. In another example embodiment, the MTP processing unit 150 may be located inside the timing control unit 160, or inside the data driving unit 130.

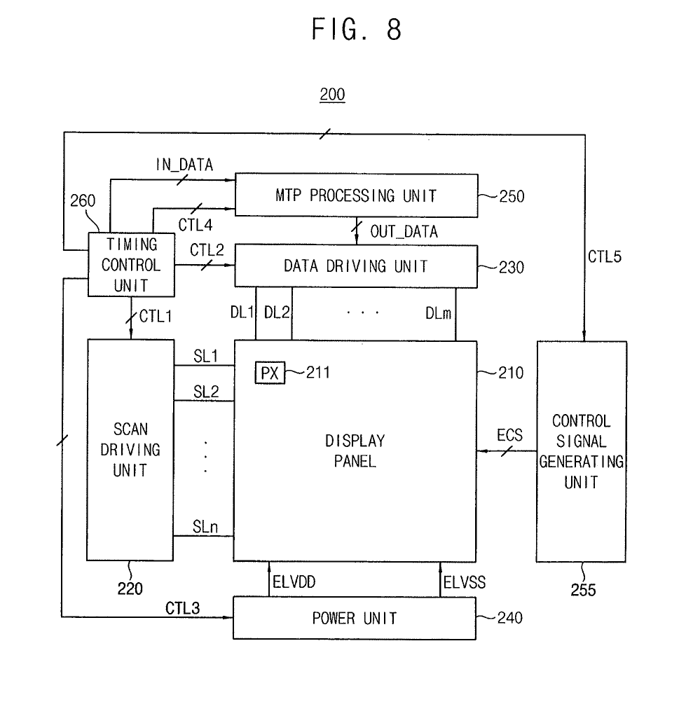

FIG. 8 is a block diagram illustrating an organic light emitting display device according to example embodiments. Referring to FIG. 8, the organic light emitting display device 200 may include a display panel 210, a scan driving unit 220, a data driving unit 230, a power unit 240, an MTP processing unit 250, a control signal generating unit 255, and a timing control unit 260. For example, the organic light emitting display device 200 may employ a simultaneous emission driving technique. The display panel 210 may include pixel circuits 211. The display panel 210 may be coupled to the scan driving unit 220 via scan-lines SL1 through SLn, and may be coupled to the data driving unit 230 via data-lines DL1 through DLm.

In one example embodiment, the pixel circuits 211 may include red color pixel circuits, green color pixel circuits, and blue color pixel circuits. In another example embodiment, the pixel circuits 211 may include red color pixel circuits, green color pixel circuits, blue color pixel circuits, and white color pixel circuits.

The scan driving unit 220 may provide a scan signal to the pixel circuits 211 via the scan-lines SL1 through SLn. The data driving unit 230 may provide a data signal to the pixel circuits 211 via the data-lines DL1 through DLm. The power unit 240 may provide a high power voltage ELVDD and a low power voltage ELVSS to the pixel circuits 211 via power-lines. The MTP processing unit 250 may perform an MTP operation by calculating respective MTP offsets at sub-reference gray-levels that are selected among predetermined reference gray-levels, where the MTP operation is performed at the reference gray-levels, for the respective pixel circuits 211, and by determining respective offset reference values, where the MTP operation is performed based on the respective offset reference values, based on the respective MTP offsets for the respective pixel circuits 211.

In one example embodiment, as illustrated in FIG. 8, the MTP processing unit 250 may be located outside the timing control unit 260 and the data driving unit 230. In another example embodiment, the MTP processing unit 250 may be located inside the timing control unit 260, or inside the data driving unit 230. The control signal generating unit 255 may provide an emission control signal ECS to the display panel 210, where the emission control signal ECS controls the pixel circuits 211 of the display panel 210 to simultaneously emit light. The timing control unit 260 may control the scan driving unit 220, the data driving unit 230, the power unit 240, the MTP processing unit 250, and the control signal generating unit 255 based on first through fifth control signals CTL1, CTL2, CTL3, CTL4, and CTL5.

By way of summation and review, the organic light emitting display device 200 may perform the MTP operation in a wide range by calculating the respective MTP offsets at the sub-reference gray-levels that are selected among the reference gray-levels for the respective pixel circuits 211 and by determining the respective offset reference values based on the respective MTP offsets (i.e., by assigning the respective offset rooms depending on a size of the respective MTP offsets). As a result, the organic light emitting display device 200 may display (i.e., output) a high-quality image by performing the MTP operation in a wide range.

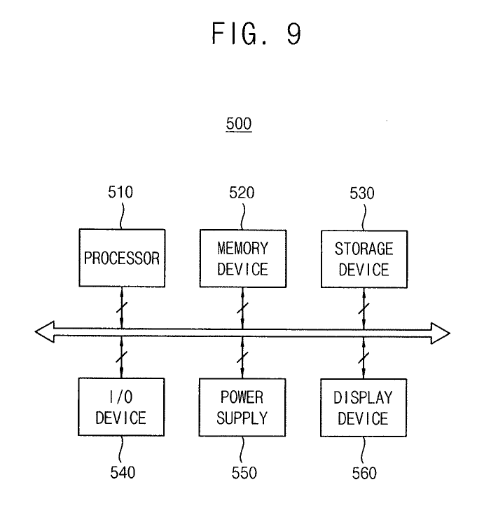

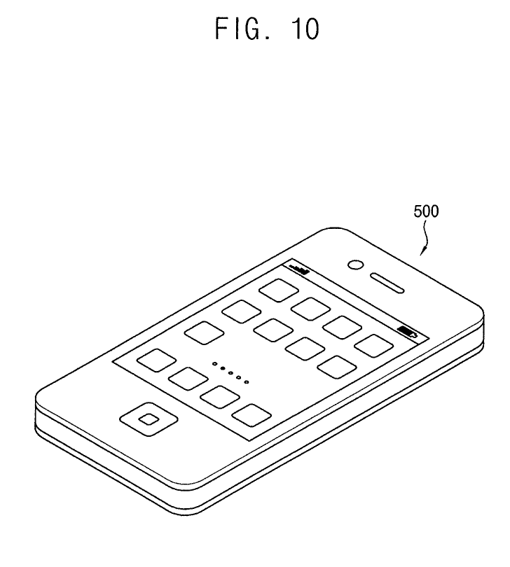

FIG. 9 is a block diagram illustrating an electronic device having an organic light emitting display device according to example embodiments. FIG. 10 is a diagram illustrating an example in which an electronic device of FIG. 9 is implemented as a smart-phone.

Referring to FIGS. 9 and 10, the electronic device 500 may include a processor 510, a memory device 520, a storage device 530, an input/output (I/O) device 540, a power supply 550, and an organic light emitting display device 560. Here, the organic light emitting display device 560 may correspond to the organic light emitting display device 100 of FIG. 6, or the organic light emitting display device 200 of FIG. 8. In addition, the electronic device 500 may further include a plurality of ports for communicating a video card, a sound card, a memory card, a universal serial bus (USB) device, other electronic devices, etc. In one example embodiment, as illustrated in FIG. 10, the electronic device 500 may be implemented as the smart-phone. However, an implementation of the electronic device 500 is not limited thereto.

The processor 510 may perform various computing functions. The processor 510 may be a micro processor, a central processing unit (CPU), etc. The processor 510 may be coupled to other components via an address bus, a control bus, a data bus, etc. Further, the processor 510 may be coupled to an extended bus such as a peripheral component interconnection (PCI) bus. The memory device 520 may store data for operations of the electronic device 500.

For example, the memory device 520 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 530 may be a solid state drive (SSD) device, a hard disk drive (HDD) device, a CD-ROM device, etc.

The I/O device 540 may be an input device such as a keyboard, a keypad, a touchpad, a touch-screen, a mouse, etc, and an output device such as a printer, a speaker, etc. In some example embodiments, the organic light emitting display device 560 may be included in the I/O device 540. The power supply 550 may provide a power for operations of the electronic device 500. The organic light emitting display device 560 may communicate with other components via the buses or other communication links.

In one example embodiment, the organic light emitting display device 560 may include a display panel, a scan driving unit, a data driving unit, a power unit, an MTP processing unit, and a timing control unit. In another example embodiment, the organic light emitting display device 560 may include a display panel, a scan driving unit, a data driving unit, a power unit, an MTP processing unit, a control signal generating unit, and a timing control unit.

The MTP processing unit may calculate respective MTP offsets at sub-reference gray-levels that are selected among predetermined reference gray-levels, where the MTP operation is performed at the reference gray-levels, for respective pixel circuits, may determine respective offset reference values, where the MTP operation is performed based on the respective offset reference values, by assigning respective offset rooms based on the respective MTP offsets for the respective pixel circuits, and may store respective gamma offsets by performing the MTP operation based on the respective offset reference values for the respective pixel circuits. As a result, the MTP operation may be performed in a wide range without increasing an offset range of the respective gamma offsets. Although it is described above that the embodiments are applied to the organic light emitting display device, embodiments may also be applied to a liquid crystal display (LCD) device.

Embodiments may be applied to an electronic device having a display device. For example, embodiments may be applied to a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

By way of summation and review, conventionally, the MTP operation cannot be performed if the gamma offset has a value out of an offset range (e.g., 8 bits (−127˜128)) supported by a driving integrated circuit (D-IC). In addition, it is difficult to increase the offset range supported by the driving integrated circuit to have a value such as 16 bits, 32 bits, etc because a size of the driving integrated circuit has limits and/or a time required for the MTP operation has limits.

In contrast, example embodiments may perform the MTP operation in a wide range by calculating the respective MTP offsets at the sub-reference gray-levels that are selected among the reference gray-levels and by determining the respective offset reference values based on the respective MTP offsets, without increasing the original offset range of the respective gamma offsets. Further, an organic light emitting display device according to example embodiments may display (i.e., output) a high-quality image by employing the method of performing the MTP operation.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of performing a multi-time programmable (MTP) operation, the method comprising:
calculating respective MTP offsets at sub-reference gray-levels selected among predetermined reference gray-levels for respective pixel circuits, the MTP operation being performed at the predetermined reference gray-levels;
determining respective offset reference values by assigning respective offset rooms based on the respective MTP offsets for the respective pixel circuits, the MTP operation being performed based on the respective offset reference values; and
storing respective gamma offsets by performing the MTP operation based on the respective offset reference values for the respective pixel circuits.

2. The method of claim 1, wherein the respective pixel circuits include a red color pixel circuit, a green color pixel circuit, and a blue color pixel circuit.

3. The method of claim 2, wherein the respective pixel circuits further include a white color pixel circuit.

4. The method of claim 1, wherein the sub-reference gray-levels are at least two low-luminance reference gray-levels that are selected among the predetermined reference gray-levels.

5. The method of claim 4, wherein:
the respective offset reference values are selected among an upper offset reference value, a lower offset reference value, and an initial offset reference value at the sub-reference gray-levels for the respective pixel circuits, and
the upper offset reference value is greater than the initial offset reference value and the lower offset reference value is smaller than the initial offset reference value.

6. The method of claim 5, wherein the upper offset reference value corresponds to a maximum value of an initial offset range and the lower offset reference value corresponds to a minimum value of the initial offset range.

7. The method of claim 6, wherein the respective offset reference values are set to be the maximum value of the initial offset range at the sub-reference gray-levels for the respective pixel circuits when the respective MTP offsets have a value greater than a predetermined maximum value for the respective pixel circuits.

8. The method of claim 7, wherein respective offset ranges are increased with respect to the initial offset range at the sub-reference gray-levels for the respective pixel circuits when the respective offset reference values are set to be the maximum value of the initial offset range at the sub-reference gray-levels for the respective pixel circuits.

9. The method of claim 6, wherein the respective offset reference values are set to be the minimum value of the initial offset range at the sub-reference gray-levels for the respective pixel circuits when the respective MTP offsets have a value smaller than a predetermined minimum value for the respective pixel circuits.

10. The method of claim 9, wherein respective offset ranges are decreased with respect to the initial offset range at the sub-reference gray-levels for the respective pixel circuits when the respective offset reference values are set to be the minimum value of the initial offset range at the sub-reference gray-levels for the respective pixel circuits.

11. The method of claim 6, wherein the respective offset reference values are set to be the initial offset reference value at the sub-reference gray-levels for the respective pixel circuits when the respective MTP offsets have a value between a predetermined minimum value and a predetermined maximum value for the respective pixel circuits.

12. The method of claim 11, wherein respective offset ranges correspond to the initial offset range at the sub-reference gray-levels for the respective pixel circuits when the respective offset reference values are set to be the initial offset reference value at the sub-reference gray-levels for the respective pixel circuits.

13. The method of claim 6, wherein respective offset ranges correspond to the initial offset range at the predetermined reference gray-levels except for the sub-reference gray-levels for the respective pixel circuits.

14. A display device, comprising:
a display panel having a plurality of pixel circuits;
a scan driving unit that provides a scan signal to the pixel circuits;
a data driving unit that provides a data signal to the pixel circuits;
a power unit that provides a high power voltage and a low power voltage to the pixel circuits;
a multi-time programmable (MTP) processing unit that performs an MTP operation by calculating respective MTP offsets at sub-reference gray-levels that are selected among predetermined reference gray-levels for the respective pixel circuits, and by determining respective offset reference values based on the respective MTP offsets for the respective pixel circuits; and
a timing control unit that controls the scan driving unit, the data driving unit, the power unit, and the MTP processing unit.

15. The device of claim 14, wherein the respective pixel circuits include a red color pixel circuit, a green color pixel circuit, and a blue color pixel circuit.

16. The device of claim 15, wherein the respective pixel circuits further include a white color pixel circuit.

17. The device of claim 14, wherein the sub-reference gray-levels are at least two low-luminance reference gray-levels that are selected among the predetermined reference gray-levels.

18. The device of claim 17, wherein:
the respective offset reference values are selected among an upper offset reference value, a lower offset reference value, and an initial offset reference value at the sub-reference gray-levels for the respective pixel circuits, and
the upper offset reference value is greater than the initial offset reference value and the lower offset reference value is smaller than the initial offset reference value.

19. The device of claim 14, wherein the MTP processing unit determines the respective offset reference values by assigning respective offset rooms based on the respective MTP offsets for the respective pixel circuits, and stores respective gamma offsets by performing the MTP operation based on the respective offset reference values for the respective pixel circuits.

20. The device of claim 19, wherein the MTP processing unit adjusts the data signal based on the respective gamma offsets for the respective pixel circuits.
